(19) United States
(12) Patent Application Publication
(10) Pub. No.: US 2013/0330648 A1
(43) Pub. Date: Dec. 12, 2013

(54) FLAT TUBULAR SOLID-OXIDE FUEL CELL, AND FLAT TUBULAR SOLID-OXIDE WATER ELECTROLYSIS APPARATUS

(71) Applicants: Sun-Dong Kim, Daejeon (KR); In-Sub Han, Chungcheongnam-do (KR); Doo-Won Seo, Daejeon (KR); Ji-Haeng Yu, Daejeon (KR); Se-Young Kim, Gyeonggi-do (KR); Sang-Kuk Woo, Daejeon (KR)

(72) Inventors: Sun-Dong Kim, Daejeon (KR); In-Sub Han, Chungcheongnam-do (KR); Doo-Won Seo, Daejeon (KR); Ji-Haeng Yu, Daejeon (KR); Se-Young Kim, Gyeonggi-do (KR); Sang-Kuk Woo, Daejeon (KR)

(73) Assignee: KOREA INSTITUTE OF ENERGY RESEARCH, Daejeon (KR)

(21) Appl. No.: 14/000,896

(22) PCT Filed: Feb. 24, 2012
(86) PCT No.: PCT/KR2012/001444

§ 371 Date: Aug. 22, 2013

(30) Foreign Application Priority Data
Feb. 24, 2011 (KR) 10-2011-0016615

(51) Int. Cl. H01M 8/24; H01M 8/10; H01M 8/00; C25B 9/18

(52) U.S. Cl. CPC H01M 8/2485; C25B 9/18; H01M 8/10; H01M 8/004
USPC 429/459; 204/258

(57) ABSTRACT

The present invention relates to a flat tubular solid-oxide fuel cell and to a water electrolysis apparatus. More particularly, the present invention relates to a flat tubular solid-oxide fuel cell and to a water electrolysis apparatus, wherein the flat tubular solid-oxide fuel cell comprises: a cell stack including a plurality of flat tubular unit cells; and first manifolds which are made of ceramic materials, and each of which has a first reaction gas inlet/outlet portion for the entry/exit of a first reaction gas to/from the cell stack and a first insertion portion for the insertion of either of the two ends of the cell stack, wherein the first manifolds are arranged at both ends of the cell stack, respectively, to thereby simplify the structure of the fuel cell and minimize the number of sealing portions in order to reduce the loss of reaction gas or the like.

### TECHNICAL FIELD

The present invention relates to a flat tubular solid oxide fuel cell and to a flat tubular solid oxide water electrolysis apparatus.

### BACKGROUND ART

A solid oxide fuel cell (SOFC) is a complete solid-state device using an oxygen ion conductive electrolyte. The solid oxide fuel cell is an eco-friendly fuel cell having high efficiency and is recently receiving attention as a next-generation source of clean energy. The solid oxide fuel cell is classified into a flat solid oxide fuel cell and a cylindrical solid oxide fuel cell, depending on the shape thereof.

The flat solid oxide fuel cell is advantageous because its power density, that is, power output, is high. However, the flat solid oxide fuel cell is disadvantageous because a sealed gas area is large, and thermal shock occurs due to a difference in the coefficient of thermal expansion between the materials which are stacked, and such a fuel cell is difficult to manufacture so as to have a large area.

The cylindrical solid oxide fuel cell is comparatively high in terms of mechanical strength and resistance to thermal stress, may be manufactured using extrusion and may be manufactured so as to have a large area. However, the cylindrical solid oxide fuel cell is problematic because its power density, that is, power output, is low.

A fuel cell manufactured using the advantages of such flat and cylindrical solid oxide fuel cells is a flat tubular solid oxide fuel cell. The flat tubular solid oxide fuel cell is advantageous because its power density, that is, power output, is higher and mechanical strength and resistance to thermal stress are superior, compared to a cylindrical solid oxide fuel cell.

Meanwhile, the flat tubular solid oxide fuel cell is made up of a cell stack comprising unit cells and manifolds. As such, an anode and a cathode should be separated from each other by sealing the unit cells and the manifolds, and the number of parts and sealing portions is increased to seal the manifolds in respective unit cells, which is undesirable. Furthermore, because a large number of manifolds are provided, a reaction gas, such as hydrogen, water vapor, etc., should be supplied via a plurality of channels, which is undesirable.

### DISCLOSURE

### Technical Problem

An object of the present invention is to provide a flat tubular solid oxide fuel cell and a water electrolysis apparatus, wherein a simple configuration able to feed a reaction gas through manifolds provided at both ends of a cell stack may be achieved.

Another object of the present invention is to provide a flat tubular solid oxide fuel cell and a water electrolysis apparatus, wherein the number of manifolds is not increased even when the number of unit cells of a cell stack is increased.

Still another object of the present invention is to provide a flat tubular solid oxide fuel cell and a water electrolysis apparatus, wherein the number of sealing portions between manifolds and a cell stack may be minimized

Yet another object of the present invention is to provide a flat tubular solid oxide fuel cell and a water electrolysis apparatus, wherein air may uniformly flow in a cell stack comprising stacked unit cells.

### Technical Solution

In order to accomplish the above objects, the present invention provides a flat tubular solid oxide fuel cell, comprising a cell stack including a plurality of flat tubular unit cells; and first manifolds provided at both ends of the cell stack and made of a ceramic, each of which includes a first reaction gas port configured to feed/discharge a first reaction gas to/from the cell stack and a first insertion portion into which either of the ends of the cell stack is inserted.

In addition, the present invention provides a flat tubular solid oxide water electrolysis apparatus, comprising a cell stack including a plurality of flat tubular unit cells; and first manifolds provided at both ends of the cell stack and made of a ceramic, each of which includes a first reaction gas port configured to feed/discharge a first reaction gas to/from the cell stack and a first insertion portion into which either of the ends of the cell stack is inserted.

### Advantageous Effects

In a flat tubular solid oxide fuel cell and a water electrolysis apparatus according to the present invention, both ends of a cell stack are inserted into first manifolds, a first reaction gas can be fed to/discharged from the cell stack through the first manifolds, thus simplifying the configuration of the flat tubular solid oxide fuel cell, thereby making it possible to reduce the size of the flat tubular solid oxide fuel cell.

In the flat tubular solid oxide fuel cell and the water electrolysis apparatus according to the present invention, even when the number of unit cells of the cell stack is increased to raise power output, there is no need to increase the number of first manifolds provided at both ends of the cell stack, thus reducing the manufacturing costs of the flat tubular solid oxide fuel cell and the water electrolysis apparatus, thereby generating economic benefits.

In the flat tubular solid oxide fuel cell and the water electrolysis apparatus according to the present invention, a pair of first manifolds are provided at both ends of the cell stack, and thus the number of sealing portions between the first manifolds and the cell stack can be minimized, and the loss of a reaction gas, etc., can also be minimized.

In the flat tubular solid oxide fuel cell and the water electrolysis apparatus according to the present invention, a second manifold is provided at any one of lateral sides of the cell stack, so that air can uniformly flow in the cell stack, thus efficiently producing electricity.

### DESCRIPTION OF DRAWINGS

FIG. 1 is a perspective view illustrating first manifolds according to the present invention;

FIG. 2 is a perspective view illustrating a flat tubular solid oxide fuel cell including a cell stack and first manifolds, according to the present invention;

FIG. 3 is a cross-sectional view illustrating unit cells of the cell stack of the flat tubular solid oxide fuel cell, according to an embodiment of the present invention;

FIG. 4 is a cross-sectional view illustrating unit cells of the cell stack of the flat tubular solid oxide fuel cell, according to another embodiment of the present invention;

FIG. 5 is a perspective view illustrating a flat tubular solid oxide fuel cell including a cell stack, first manifolds and a second manifold, according to the present invention;

FIG. 6 is a perspective view illustrating the flat tubular solid oxide fuel cell including a cell stack, first manifolds and a second manifold, according to the present invention;

FIG. 7 is a view illustrating the rate (m/s) of gas flow in the flat tubular solid oxide fuel cell according to the present invention;

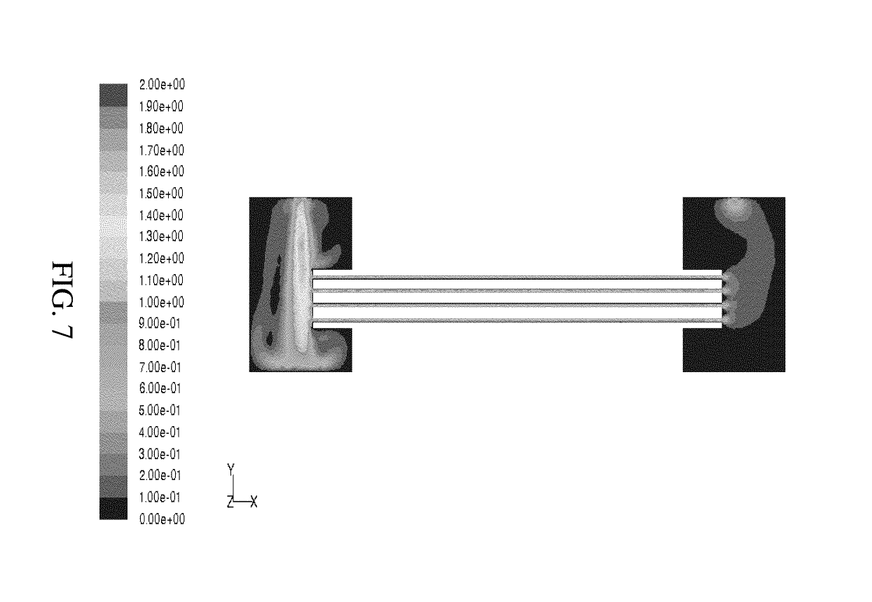

FIG. 8 is a view illustrating the gas flow in the flat tubular solid oxide fuel cell according to the present invention; and

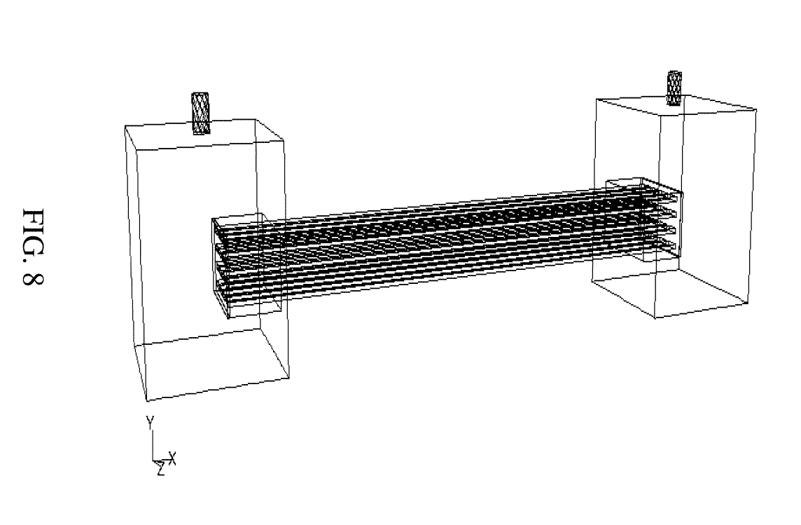

FIG. 9 is a view illustrating the rate (m/s) of gas flow in the flat tubular solid oxide fuel cell according to the present invention.

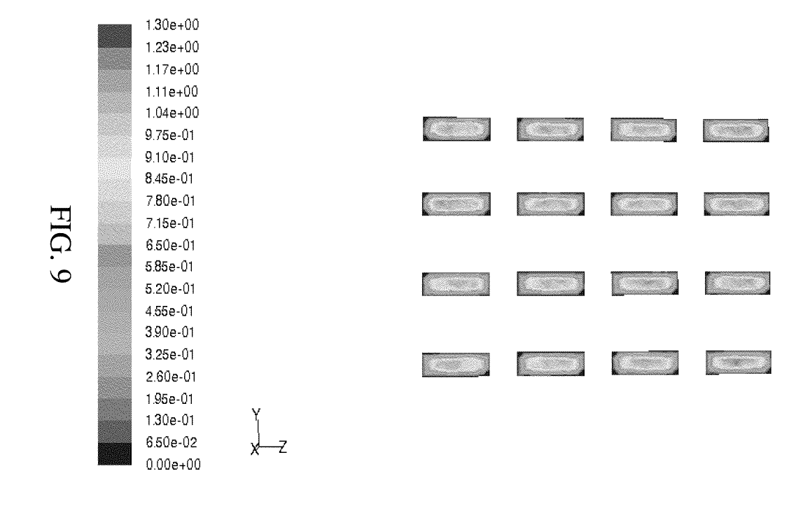

<Description of the Reference Numerals in the Drawings>

| | |
|---|---|
| 11: cell stack | 21: first manifold |
| 22: second manifold | 111a: first electrode support |
| 111b: first electrode intermediate layer | |
| 111c: electrolyte layer | |
| 111e: second electrode layer | |
| 112: first reaction gas flow channel | |
| 113: second reaction gas flow channel | |
| 115: ceramic conductor | |
| 116: sealing groove | 150: sealant |
| 211: first reaction gas port | |
| 212: first insertion portion | |
| 221: second reaction gas inlet | |
| 222: second insertion portion | |

### MODE FOR INVENTION

Hereinafter, preferred embodiments which may be easily performed by a person having ordinary knowledge in the art to which the present invention belongs are described in detail with reference to the appended drawings.

The present invention provides a flat tubular solid oxide fuel cell, comprising a cell stack including a plurality of flat tubular unit cells; and first manifolds provided at both ends of the cell stack and made of a ceramic, each of which has a first reaction gas port configured to feed/discharge a first reaction gas to/from the cell stack and a first insertion portion into which either of the ends of the cell stack is inserted.

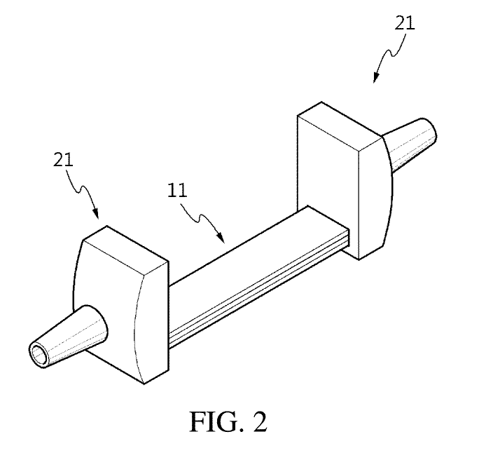

FIG. 2 illustrates the cell stack 11 and the first manifolds 21 of the flat tubular solid oxide fuel cell according to the present invention. The flat tubular solid oxide fuel cell according to the present invention includes the cell stack 11 and the first manifolds 21.

The cell stack 11 includes a plurality of unit cells, and more specifically, is configured such that a plurality of unit cells are stacked. The plurality of unit cells are sealed with a sealant, and the sealant is preferably cement or glass frit, but is not particularly limited so long as it is used in the art.

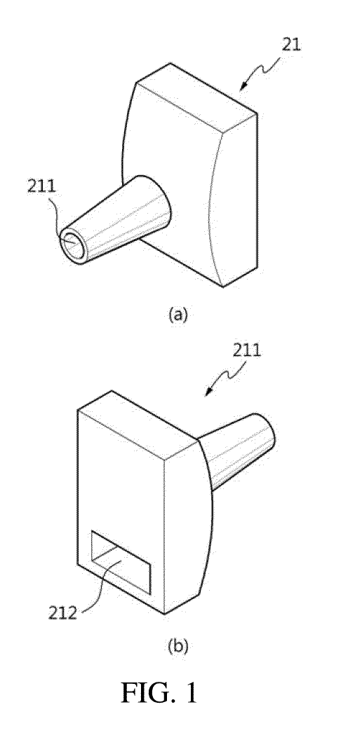

With reference to FIG. 1, the first manifolds 21 are made of a ceramic, and each includes the first reaction gas port 211 configured to feed/discharge the reaction gas to/from the cell stack 11 and the first insertion portion 212 into which either of the ends of the cell stack 11 is inserted. The size and shape of the first reaction gas port 211 are not particularly limited so long as it is used in the art. Furthermore, the size and shape of the first insertion portion 212 is not particularly limited so long as the cell stack 11 may be inserted thereto.

The first manifolds 21 are made of a ceramic, and more preferably, the ceramic may be either zirconia or alumina, but the present invention is not limited thereto. As the first manifolds 21 are made of a ceramic, they have a coefficient of thermal expansion which is similar to that of the cell stack, and have no corrosion problems and are thus stable, and also, enable the flat tubular solid oxide fuel cell to efficiently operate even at a high temperature of 700° C. or more.

FIG. 2 is a perspective view illustrating the flat tubular solid oxide fuel cell including the cell stack and the first manifolds, according to the present invention.

With reference to FIG. 2, both ends of the cell stack 11 are positioned at the first insertion portions 212 of the first manifolds 21. As such, the cell stack 11 and the first manifolds 21 are preferably sealed with a sealant. The sealant is preferably cement or glass frit, but is not particularly limited so long as it is used in the art.

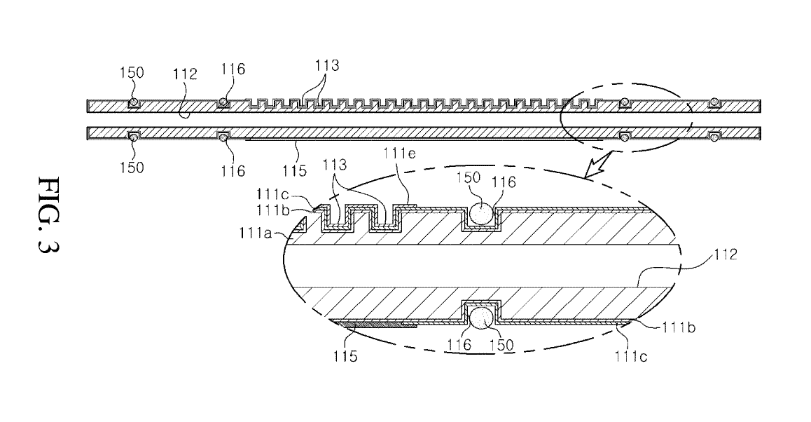

FIG. 3 is a cross-sectional view illustrating unit cells of the cell stack 11 of the flat tubular solid oxide fuel cell, according to an embodiment of the present invention.

With reference to FIG. 3, the unit cells are configured such that a plurality of first reaction gas flow channels 112 are formed along the longitudinal direction of the unit cells to enable the first reaction gas (hydrogen or hydrocarbon) to flow in first electrode supports 111a. A plurality of second reaction gas flow channels 113 in which the second reaction gas (air or oxygen) flows are formed on the outer surface of one side of the first electrode support 111a in a direction (a width direction of the first electrode support) that intersects the first reaction gas flow channels 112. Also, a first electrode intermediate layer, which will be mentioned later, is coated with a ceramic conductor 115 at the side of the unit cell opposite the side having the second reaction gas flow channels 113 so as to achieve electrical connection.

Each unit cell includes a first electrode support 111a made of a porous conductive material including an anode material, a first electrode intermediate layer 111b applied on the entire outer surface of the first electrode support 111a, an electrolyte layer 111c formed on the outer surface of the first electrode intermediate layer 111b other than the ceramic conductor 115, and a second electrode layer 111e applied on the outer surface of the electrolyte layer 111c formed on the portion having the second gas flow channels 113. The first electrode support 111a and the first electrode intermediate layer 111b are preferably nickel oxide-yttria stabilized zirconia (NiO—YSZ), and the electrode material of the second electrode layer 111e is preferably LaSrMnO₃ (LSM), and the electrolyte layer 111c is preferably yttria stabilized zirconia (YSZ), but the present invention is not limited thereto and a variety of electrode materials may be used.

The first electrode intermediate layer 111b and the second electrode layer 111e are preferably formed to be porous so as to diffuse a gas, and the electrolyte layer 111c and the ceramic conductor 115 are preferably provided in the form of a dense film having no pores so as to prevent the first gas and the second gas from being mixed.

The plurality of first reaction gas flow channels 112 formed in the unit cells are configured such that both ends of the unit cells are inserted into the first manifolds 21 and thus both ends of the unit cells are not closed but are opened so that the first reaction gas can flow through the first reaction gas flow channels 112. The plurality of second reaction gas flow channels 113 are formed in a width direction of the unit cell at the middle portion of the length of the unit cell.

The unit cells include sealing grooves 116 in a ring shape, and the sealant 150 is preferably placed in the sealing grooves 116, so that a gas does not leak from the stacked unit cells.

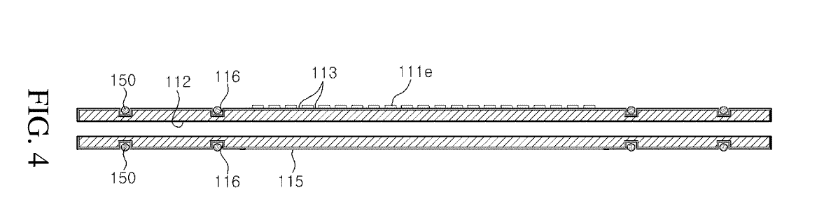

FIG. 4 is a cross-sectional view illustrating unit cells of the cell stack 11 of the flat tubular solid oxide fuel cell, according to another embodiment of the present invention.

The unit cells of FIGS. 3 and 4 are merely illustrative, and the unit cells according to the present invention are not limited thereto.

The fuel cell of the present invention may further include a second manifold including a second reaction gas inlet for feeding a second reaction gas and a second insertion portion.

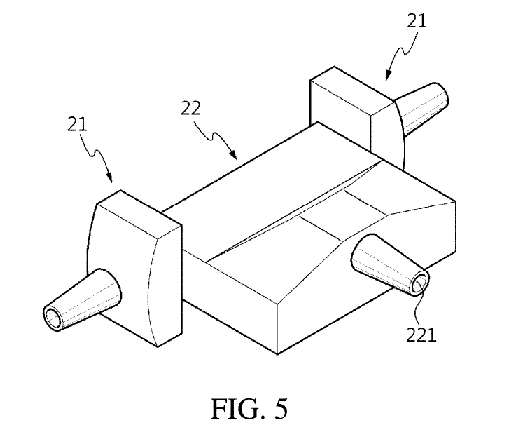

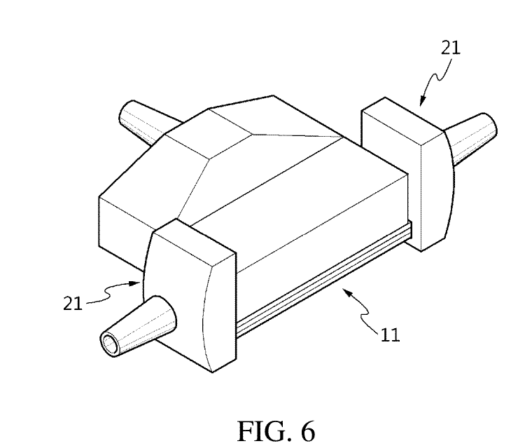

FIGS. 5 and 6 illustrate a flat tubular solid oxide fuel cell according to the present invention, which is configured such that both ends of the cell stack 11 are inserted into the first insertion portions 212 of the first manifolds 21, and one lateral side of the cell stack 11 is inserted into the second insertion portion of the second manifold 22.

With reference to FIGS. 5 and 6, the flat tubular solid oxide fuel cell having the first manifolds 21 at both ends of the cell stack 11 is preferably configured such that the second manifold 22 is additionally provided at the position where the second reaction gas is fed. As such, the second manifold 22 is made of a ceramic, and preferably includes the second reaction gas inlet 221 and the second insertion portion 222.

The first reaction gas is fed/discharged through the first reaction gas ports 211 of the first manifolds 21, and the second reaction gas is fed through the second reaction gas inlet 221 of the second manifold 22, so that the first reaction gas and the second reaction gas may uniformly flow in the cell stack, and efficiency of the solid oxide fuel cell may increase.

The second manifold 22 is made of a ceramic, and more preferably, the ceramic may be either zirconia or alumina, but the present invention is not limited thereto. As the second manifold 22 is made of a ceramic, it has a coefficient of thermal expansion similar to that of the cell stack, and has no corrosion problems and is thus stable, and enables the flat tubular solid oxide fuel cell to efficiently operate even at a high temperature of 700° C. or more.

Also, any one of lateral sides of the cell stack 11 is inserted into the second insertion portion 222 of the second manifold 22, and is preferably sealed with a sealant. As such, the sealant is preferably either cement or glass frit, but the present invention is not limited thereto.

The present invention provides a flat tubular solid oxide water electrolysis apparatus, comprising a cell stack including a plurality of flat tubular unit cells; and first manifolds provided at both ends of the cell stack and made of a ceramic, each of which includes a first reaction gas port configured to feed/discharge a first reaction gas to/from the cell stack and a first insertion portion into which either of the ends of the cell stack is inserted.

Also, a second manifold is further provided at any one of lateral sides of the cell stack, and the second manifold is made of a ceramic, and includes a second reaction gas inlet for feeding the second reaction gas and a second insertion portion into which any one of lateral sides of the cell stack is inserted.

The flat tubular solid oxide fuel cell and the water electrolysis apparatus according to the present invention may feed a reaction gas through a pair of first manifolds provided at both ends of the cell stack, thus achieving a simple configuration, whereby the volume of the fuel cell and the water electrolysis apparatus may be minimized.

In the flat tubular solid oxide fuel cell and the water electrolysis apparatus according to the present invention, even when the number of unit cells of the cell stack is increased to raise power output, there is no need to increase the number of first manifolds provided at both ends of the cell stack, whereby the manufacturing costs of the flat tubular solid oxide fuel cell and the water electrolysis apparatus may be decreased, thus generating economic benefits.

The flat tubular solid oxide fuel cell and the water electrolysis apparatus according to the present invention obviate a need to provide a manifold per unit cell of the cell stack, and first manifolds are provided at both ends of the cell stack, whereby the number of sealing portions between the first manifolds and the cell stack may be minimized, thus minimizing the loss of a reaction gas, etc.

What is claimed is:

1. A flat tubular solid oxide fuel cell, comprising:
a cell stack including a plurality of flat tubular unit cells; and
first manifolds provided at both ends of the cell stack and made of a ceramic, each of which includes a first reaction gas port configured to feed/discharge a first reaction gas to/from the cell stack and a first insertion portion into which either of the ends of the cell stack is inserted.

2. The flat tubular solid oxide fuel cell of claim 1, wherein the ceramic is zirconia or alumina.

3. The flat tubular solid oxide fuel cell of claim 1, wherein the cell stack and the first manifolds are sealed with a sealant.

4. The flat tubular solid oxide fuel cell of claim 3, wherein the sealant is cement or glass frit.

5. The flat tubular solid oxide fuel cell of claim 1, wherein a second manifold is further provided at any one of lateral sides of the cell stack, and the second manifold is made of a ceramic and includes a second reaction gas inlet for feeding a second reaction gas and a second insertion portion into which any one of lateral sides of the cell stack is inserted.

6. The flat tubular solid oxide fuel cell of claim 5, wherein the ceramic is zirconia or alumina.

7. The flat tubular solid oxide fuel cell of claim 5, wherein the cell stack and the second manifold are sealed with a sealant.

8. The flat tubular solid oxide fuel cell of claim 7, wherein the sealant is cement or glass frit.

9. A flat tubular solid oxide water electrolysis apparatus, comprising:
a cell stack including a plurality of flat tubular unit cells; and
first manifolds provided at both ends of the cell stack and made of a ceramic, each of which includes a first reaction gas port configured to feed/discharge a first reaction gas to/from the cell stack and a first insertion portion into which either of the ends of the cell stack is inserted.

10. The flat tubular solid oxide water electrolysis apparatus of claim 9, wherein a second manifold is further provided at any one of lateral sides of the cell stack, and the second manifold is made of a ceramic and includes a second reaction gas inlet for feeding a second reaction gas and a second insertion portion into which any one of lateral sides of the cell stack is inserted.
